(19) United States
(12) Patent Application Publication
(10) Pub. No.: US 2026/0080624 A1
(43) Pub. Date: Mar. 19, 2026

(54) AUTO-REGRESSIVE AUTO-ENCODER FOR ARTISTIC MESH GENERATION

(71) Applicant: NVIDIA Corporation, Santa Clara, CA (US)

(72) Inventors: Qinsheng Zhang, Atlanta, GA (US); Ming-Yu Liu, Redwood City, CA (US); Zekun Hao, Santa Clara, CA (US); Zhaoshuo Li, Santa Clara, CA (US); Jiaxiang Tang, Beijing (CN)

(21) Appl. No.: 19/255,691

(22) Filed: Jun. 30, 2025

Related U.S. Application Data
(60) Provisional application No. 63/696,795, filed on Sep. 19, 2024.

(51) Int. Cl. G06T 17/20; G06N 3/0455

(52) U.S. Cl. CPC G06T 17/20; G06N 3/0455

(57) ABSTRACT

Automatic 3D content generation, particularly the generation of polygonal meshes, is useful for development of digital gaming, virtual reality, and filmmaking. Generative models in particular make 3D asset creation more accessible to non-experts. Some existing approaches rely on continuous 3D representations which lose the discrete face indices in triangular meshes during conversion and consequently require post-processing to extract triangular meshes which will then differ significantly from artist-created ones. More recently, attempts have been made to tokenize meshes into 1D sequences and leverage auto-regressive models for direct mesh generation, which can preserve the topology information and generate artistic meshes, but these methods are inefficient, result in accuracy loss, and cannot generalize beyond the training domain. The present disclosure provides an auto-regressive auto-encoder configured for artistic mesh generation, which can compress variable-length triangular meshes into fixed-length latent codes to enable training latent diffusion models conditioned on different modalities for improved generalization.

### RELATED APPLICATION(S)

This application claims the benefit of U.S. Provisional Application No. 63/696,795 (Attorney Docket No. NVIDP1417+/24-SC-1154US01), titled “AUTO-REGRESSIVE ENCODER FOR EFFICIENT MESH GENERATION” and filed Sep. 19, 2024, the entire contents of which is incorporated herein by reference.

### TECHNICAL FIELD

The present disclosure relates to generating three-dimensional (3D) meshes in computer graphics.

### BACKGROUND

Automatic 3D content generation, particularly the generation of widely used polygonal meshes, holds the potential to revolutionize industries such as digital gaming, virtual reality, and filmmaking. Generative models can make 3D asset creation more accessible to non-experts by drastically reducing the time and effort involved. This democratization opens up opportunities for a wider range of individuals to contribute to and innovate within the 3D content space, fostering greater creativity and efficiency across these sectors.

Previous research on 3D generation has explored a variety of approaches. For example, optimization-based methods, such as using score distillation sampling (SDS), lift 2D diffusion priors into 3D without requiring any 3D data. In contrast, large reconstruction models (LRM) directly train feed-forward models to predict neural radiance fields (NeRF) or Gaussian Splatting from single or multi-view image inputs. Lastly, 3D-native latent diffusion models encode 3D assets into latent spaces and generate diverse contents by performing diffusion steps in the latent space. However, all these approaches rely on continuous 3D representations, such as NeRF or signed distance field (SDF) grids, which lose the discrete face indices in triangular meshes during conversion. Consequently, they require post-processing, such as marching cubes and re-meshing algorithms, to extract triangular meshes. These meshes differ significantly from artist-created ones, which are more concise, symmetric, and aesthetically structured. Additionally, these methods are limited to generating watertight meshes and cannot produce single-layered surfaces.

Recently, several approaches have attempted to tokenize meshes into 1D sequences and leverage auto-regressive models for direct mesh generation. Specifically, MeshGPT proposes to empirically sort the triangular faces and apply a vector-quantization variational auto-encoder (VQVAE) to tokenize the mesh. MeshXL directly flattens the vertex coordinates and does not use any compression other than vertex discretization. Since these methods directly learn from mesh vertices and faces, they can preserve the topology information and generate artistic meshes. However, these auto-regressive mesh generation approaches still face several challenges. (1) Generation of a large number of faces: due to the inefficient face tokenization algorithms, most prior methods can only generate meshes with fewer than 1,600 faces, which is insufficient for representing complex objects. (2) Generation of high-resolution surface: previous works quantize mesh vertices to a discrete grid of only 1283 resolution, which results in significant accuracy loss and unsmooth surfaces. (3) Model generalization: training auto-regressive models with difficult input modalities is challenging. Previous approaches often struggle to generalize beyond the training domain when conditioning on single-view images.

There is a need for addressing these issues and/or other issues associated with the prior art. For example, there is a need for an auto-regressive auto-encoder configured for artistic mesh generation, which can compress variable-length triangular meshes into fixed-length latent codes to enable training latent diffusion models conditioned on different modalities for improved generalization.

### SUMMARY

A method, computer readable medium, and system are disclosed for generating a variable-length mesh token sequence. An input representation of an object is encoded into a fixed length latent code. The fixed length latent code is decoded into a variable-length mesh token sequence, by an auto-regressive decoder. The variable-length mesh token sequence is output for use in generating a three-dimensional (3D) mesh for the object.

### BRIEF DESCRIPTION OF THE DRAWINGS

FIG. 1 illustrates a method for generating a variable-length mesh token sequence, in accordance with an embodiment.

FIG. 2 illustrates a mesh tokenization process, in accordance with an embodiment.

FIG. 3 illustrates a half-edge representation for triangular faces, in accordance with an embodiment.

FIG. 4 illustrates exemplary compressed meshes, in accordance with an embodiment.

FIG. 5 illustrates an auto-regressive auto-encoder pipeline, in accordance with an embodiment.

FIG. 6 illustrates a method for generating a 3D content, in accordance with an embodiment.

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 illustrates an example data center system, according to at least one embodiment.

### DETAILED DESCRIPTION

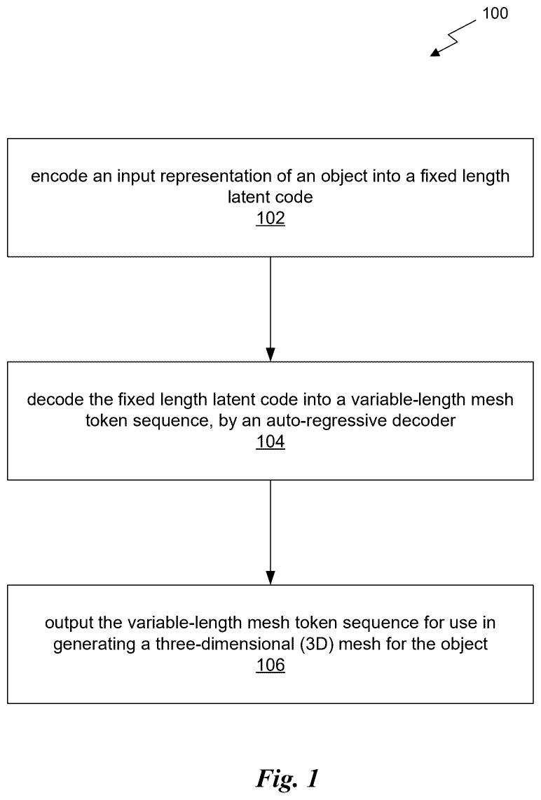

FIG. 1 illustrates a method 100 for generating a variable-length mesh token sequence, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, an input representation of an object is encoded into a fixed length latent code. The object refers to any object capable of being represented as a 3D mesh, which will be described in more detail below. For example, the object may be a human, animal, character, inanimate object, etc.

The input representation of the object refers to a representation of the object that is input to the method 100. In an embodiment, the representation of the object may be input by a user. In an embodiment, the representation of the object may be input by an application or process.

In an embodiment, the input representation of the object may be a point cloud. In an embodiment, the point cloud may be generated from a triangular mesh representing the object. For example, the point cloud may be generated using a point cloud sampler that samples from the triangular mesh. In another embodiment, the input representation of the object may be a single-view image of the object.

As mentioned, the input representation of the object is encoded into a fixed length latent code. The fixed length latent code refers to a latent code of a fixed length that has been learned by a model as a representation of the object. In an embodiment, the fixed length latent code may capture features of the object from the input representation of the object. In an embodiment, the fixed length latent code may be generated based on a predefined number of random points sampled from a surface of the input representation of the object. The encoding of the input representation of the object to the fixed length latent code may be performed using a pretrained encoder, pretrained diffusion transformer, or any pretrained model configured to encode a given representation of an object into a fixed length latent code.

In an embodiment where the input representation of the object is the point cloud, an encoder may encode the input representation of the object into the fixed length latent code. In an embodiment where the input representation of the object is the single-view image of the object, an image encoder may extract image features from the single-view image of the object and a diffusion transformer may generate the fixed length latent code conditioned on the image features. In an embodiment where the input representation of the object is of a variable length, an encoder may be configured to compress the variable length input representation of the object into the fixed length latent code.

In operation 104, the fixed length latent code is decoded into a variable-length mesh token sequence, by an auto-regressive decoder. The auto-regressive decoder refers to a trained decoder that is configured to auto-regressively decode a given fixed length latent code into a corresponding variable-length mesh token sequence. The variable-length mesh token sequence refers to a sequence of tokens that is of a variable length and that represents a 3D mesh of the object. The 3D mesh refers to a collection of vertices, edges and faces that define a shape of the object in 3D.

In an embodiment, the variable-length mesh token sequence may be a 1D token sequence. In an embodiment, the variable-length mesh token sequence may be a lossless compressed representation of the 3D mesh. In an embodiment, the variable-length mesh token sequence may exhibit at least 40% compression of the 3D mesh. In an embodiment, the variable-length mesh token sequence may be generated using a tokenizer that maximizes edge sharing between adjacent triangles, where each next triangle only requires one additional vertex by sharing an edge with a previous triangle.

In operation 106, the variable-length mesh token sequence is output. As mentioned, the variable-length mesh token sequence may be a lossless compressed representation of a 3D mesh of the object. Accordingly, fewer resources (e.g. bandwidth, memory, etc.) may be required to output of the variable-length mesh token sequence than would be required to output a generated 3D mesh of the object.

In an embodiment, the variable-length mesh token sequence may be output for use in generating the 3D mesh for the object. In an embodiment, the variable-length mesh token sequence may be output to a de-tokenizer that transforms the variable-length mesh token sequence into the 3D mesh. In an embodiment, the variable-length mesh token sequence may be communicated over a network to the de-tokenizer. In an embodiment, the de-tokenizer may transform the variable-length mesh token sequence into the 3D mesh conditioned on a defined face count that controls a number of faces included in the 3D mesh. In an embodiment, the defined face count is customizable (e.g. by a user).

In a further embodiment of the method 100, the 3D mesh may be output to a downstream application. In an embodiment, the downstream application may generate 3D content using the 3D mesh. For example, the 3D content may be generated for use with virtual reality, augmented reality, etc. applications.

The embodiments disclosed herein with reference to the method 100 of FIG. 1 may apply to and/or be used in combination with any of the embodiments of the remaining figures below.

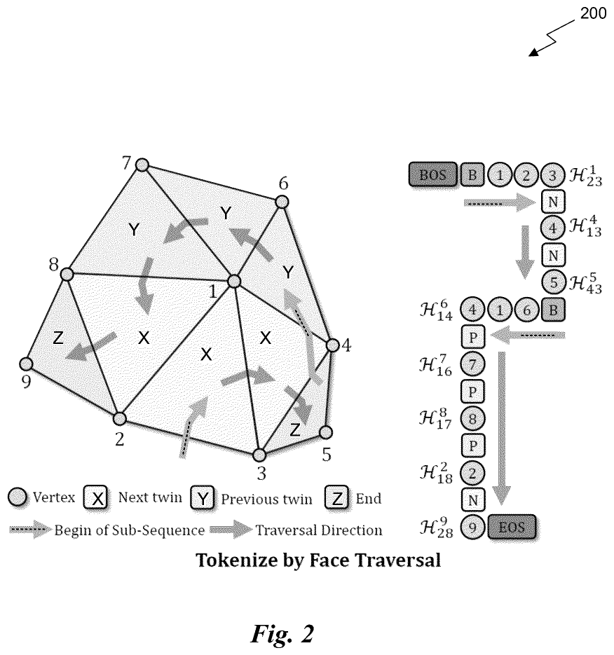

FIG. 2 illustrates a mesh tokenization process 200, in accordance with an embodiment.

Auto-regressive models process information in the form of discrete token sequences. Thus, compact tokenization is crucial as it allows information to be represented with fewer tokens accurately. However, tokenization techniques used in prior auto-regressive mesh generation works mainly suffer from two issues: (1) Some prior works use lossy vector quantized-variational auto-encoders (VQ-VAEs), which sacrifices the mesh generation quality; and (2) Others opt for zero compression by not using face tokenizers, which poses training challenges due to the inefficiency.

The tokenization process 200 described herein allows a mesh to be represented compactly and efficiently, based on a triangular mesh compression algorithm. A tokenizer performs the tokenization process 200 by traversing the 3D mesh triangle-by-triangle and converts it into a 1D token sequence. In particular, edge sharing between adjacent triangles may be maximized for mesh compression. By sharing an edge with the previous triangle, the next triangle requires only one additional vertex instead of three.

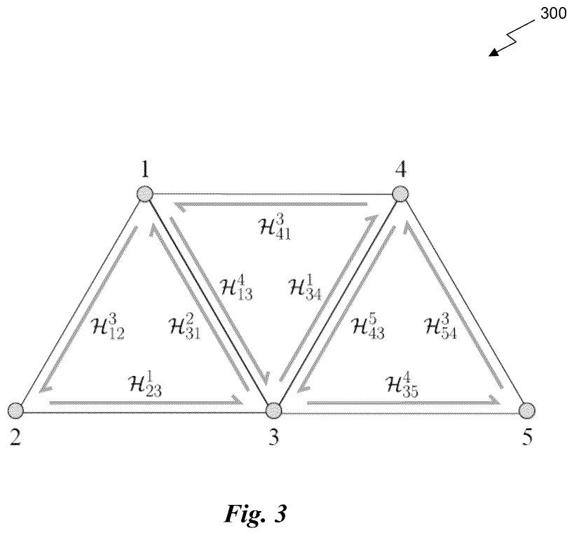

Half-edge. A half-edge data structure is used to represent the input mesh for triangular face traversal. As illustrated in FIG. 3, [symbol] : to denote a half-edge. For example, [symbol] is the half-edge pointing from vertex 4 to 1, with vertex 3 across the face. Starting from [symbol] , we can traverse to the next half-edge [symbol] and the next twin half-edge [symbol] . Reversely, the previous half-edge is [symbol] and the previous twin half-edge is [symbol] .

Vertex Tokenization. To tokenize a mesh into a discrete sequence, vertex coordinates require discretization. The mesh is normalized to a unit cube and the continuous vertex coordinates are quantized into integers according to a quantization resolution, which is 512 in the present example. Each vertex is therefore represented by three integer coordinates, which are then flattened in XYZ order as tokens. With some abuse of notion, we denote the XYZ tokens as a single vertex token using gray circle.

Face Tokenization. We traverse through all faces following the half-edges. The process 200 is illustrated in the mesh example of FIG. 2. The process starts with one half-edge, where [symbol] is picked as the beginning of the current traversal. We signify the start of a traversal as B. We then append the vertex across the half-edge 1 as the first vertex token. Within the same triangular face, the two vertices 2 and 3 are also appended following the direction of [symbol] .

During traversal, we visit the next twin half-edge whenever possible, and only reverse the half-edge direction to the previous twin half-edge when we exhaust all triangles in the current traversal. Returning to the example in FIG. 2, we follow [symbol] and reach [symbol] . Thus, we append N to signify the next twin traversal direction and we only need to append 4 as 1 and 3 are shared. The same process is repeated for [symbol] with N 5 added to the current sub-sequence.

We have completed the current traversal as no adjacent faces can be found for [symbol] The sub-sequence for the current traversal is thus B 1 2 3 N 4 N 5.

To begin a new sub-sequence, we reversely retrieve the last-added half-edges to traverse in the opposite directions. As the last-added half-edge [symbol] doesn't have any adjacent faces, we skip it and instead consider [symbol] . We go opposite to its previous twin half-edge [symbol] As this is a new sub-sequence, B 6 1 4 are added.

We continue finding the un-visited faces in the neighborhood of [symbol] and arriving at its previous twin half-edge [symbol] . Thus, we add P 7 to the current sub-mesh sequence as 6 and 1 are shared. The process is repeated and P 8 P 2 N 9 are added. As all triangular faces have been visited, the face tokenization process of the mesh is complete.

Auxiliary Tokens. A BOS (beginning of sequence token) is prepended at the beginning of a mesh sequence and a EOS (end of sequence token) is appended at the end of a mesh sequence.

Detokenization. It is straightforward to reconstruct the original mesh from a mesh token sequence. The tokens are iterated over while maintaining a state machine. Each B of a sub-sequence is always followed by three vertex tokens. Each N or P is followed by a single vertex token, and two previous vertex tokens are retrieved based on the traversal direction to reconstruct the triangle. Finally, duplicate vertices are merged, as they may appear multiple times from different sub-sequences, and the reconstructed mesh is output.

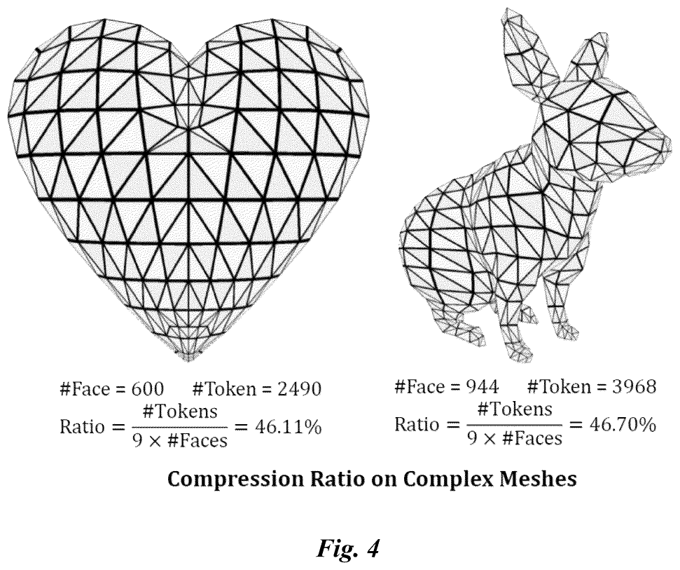

The tokenizer process 200 can benefit model training in several ways:
(1) Each face requires an average of 4 to 5 tokens, achieving approximately 50% compression compared to the 9 tokens used in previous works. This increased efficiency enables the model to generate more faces with the same number of tokens and facilitates training on datasets containing a higher number of faces. Examples of this compression ratio are illustrated in FIG. 4.
(2) The traversal is designed to avoid long-range dependency between tokens. Each token only relies on a short context of previous tokens, which further mitigate the difficulty of learning.
(3) The traversal ensures that each face's orientation remains consistent within each sub-mesh. Consequently, the generated mesh can be accurately rendered using back face culling, a feature not consistently achieved in prior methods.

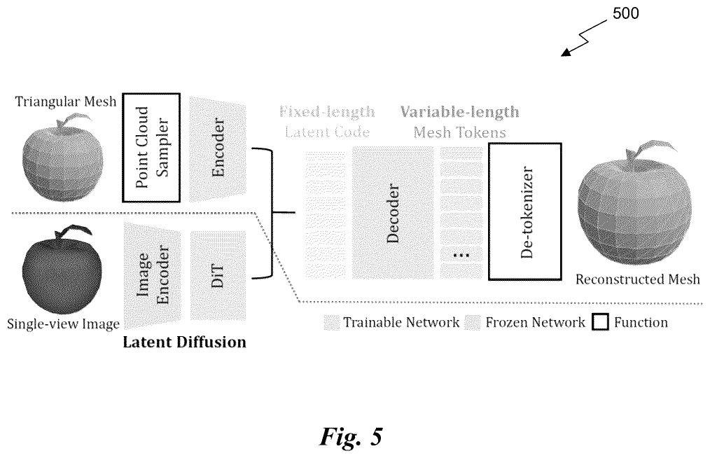

FIG. 5 illustrates an auto-regressive auto-encoder pipeline 500, in accordance with an embodiment. The pipeline 500 may be implemented to carry out the method 100 of FIG. 1, in an embodiment. Thus, the descriptions and definitions provided above may equally apply to the present embodiment.

The auto-regressive auto-encoder pipeline 500 includes a model with a lightweight encoder and an auto-regressive decoder. The illustrated de-tokenizer may not necessarily be a component of the auto-regressive auto-encoder model, but may be implemented on a same or different computing system as the model.

With regard to the pipeline 500, to extract geometric information from an input mesh surface, a point cloud is sampled and a transformer encoder is applied. Specifically, N random points, X∈ [symbol] , are sampled from the surface of the input mesh and a cross-attention layer is used to extract the latent code, per Equation 1.

$$Z = CrossAtt ( Q , PosEmbed ( X ) ) \qquad Equation 1$$

where Q∈ [symbol] represents the trainable query embedding with a hidden dimension of C, PosEmbed(·) is a frequency embedding function for 3D points, and Z∈ [symbol] represents the latent code, where M<N and L<C denote the latent size and dimension, respectively.

The decoder is an auto-regressive transformer, designed to generate a variable-length mesh token sequence. In an embodiment, a learnable embedding converts discrete tokens into continuous features, and a linear head maps predicted features back to classification logits. Stacked causal self-attention layers are employed to predict the next token based on previous tokens. The latent code Z is prepended to the input before the BOS token, allowing the decoder to learn how to generate a mesh token sequence conditioned on the latent code.

### Face Count Condition

Given a point cloud or a single-view image as input, multiple plausible meshes with varying numbers of faces and topologies can be generated. The number of faces is particularly crucial as it directly affects the mesh's complexity (low-poly versus high-poly) and the generation speed. To manage meshes with a broad range of face counts, some level of explicit (i.e. user input) control over the targeted number of faces is enabled. This control facilitates the estimation of generation time and the complexity of the generated mesh during inference. A face count conditioning method is provided for coarse-grained control. Specifically, a learnable face count token is appended after the latent code condition tokens. Face count is bucketed into different ranges and different tokens are assigned to each range. For example, four distinct tokens can be used to represent face counts in the following ranges: less than or equal to 1000, between 1000 and 2000, between 2000 and 4000, and greater than 4000. Additionally, during training, these tokens are randomly replaced with a fifth unconditional token. This approach ensures that the model still learns to generate meshes without specifying a targeted face count.

Loss Function. The auto-regressive auto-encoder model is trained using the standard cross-entropy loss on the predicted next tokens, per Equation 2.

$${ℒ}_{ce} = CrosdEntropy ( S [ : - 1 ] , S [ 1 : ] ) \qquad Equatio 2$$

where S denotes the one-hot ground truth token sequence, and Ŝ represents the predicted classification logits sequence. Additionally, to constrain the range of the latent space for easier training of subsequent diffusion models, an L2 norm penalty is applied to the latent code, per Equation 3.

$${ℒ}_{reg} = {‖ Z ‖}_{2}^{2} \qquad Equation 3$$

The final loss is a weighted combination of the cross-entropy loss and the regularization term.

### Image Conditioned Latent Diffusion

With the fixed-length latent space provided by the auto-regressive auto-encoder pipeline 500, it is now feasible to train mesh generation models conditioned on different inputs, akin to how 2D image generation models are trained. Among various input modalities, the auto-regressive auto-encoder model may be used for example to generate mesh from single-view images.

In an embodiment, a diffusion transformer (DiT) may be used as the backbone, employing an image encoder to extract image features for conditioning and cross-attention layers to integrate the image condition into the denoising features, while Adaptive Layer Normalization (AdaLN) layers incorporate timestep information. A denoising diffusion probabilistic model (DDPM) framework and mean square error (MSE) loss may be used to train the DiT model. At each training step, a timestep t and a Gaussian noise ∈∈ [symbol] is randomly sampled. The loss is calculated between the predicted noise and the random noise.

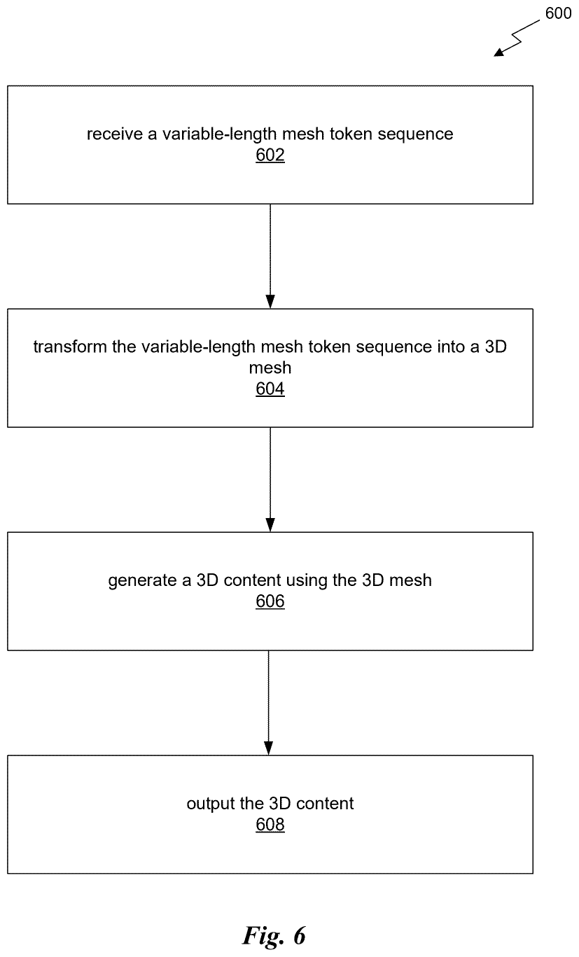

FIG. 6 illustrates a method 600 for generating a 3D content, in accordance with an embodiment. The method 600 may be carried out by the de-tokenizer of FIG. 5, in an embodiment.

In operation 602, a variable-length mesh token sequence is received. The variable-length mesh token sequence may be generated per the method 100 of FIG. 1, for example. The variable-length mesh token sequence may represent a particular 3D object.

In operation 604, the variable-length mesh token sequence is transformed into a 3D mesh. In an embodiment, the variable-length mesh token sequence may be transformed by the de-tokenizer illustrated in FIG. 5. In an embodiment, the variable-length mesh token sequence may be transformed into the 3D mesh as conditioned on a defined (i.e. customized) face count that controls a number of faces included in the 3D mesh.

In operation 606, a 3D content is generated from the 3D mesh. In an embodiment, the 3D content may be generated for a downstream application. For example, the 3D content may be generated for use with virtual reality, augmented reality, etc. applications.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

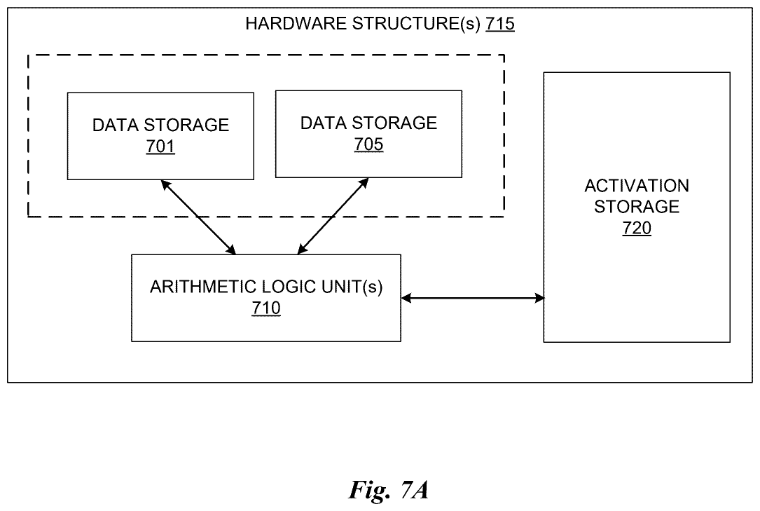

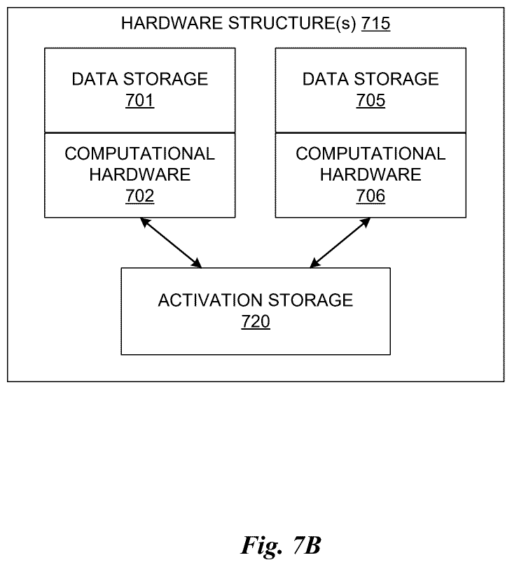

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

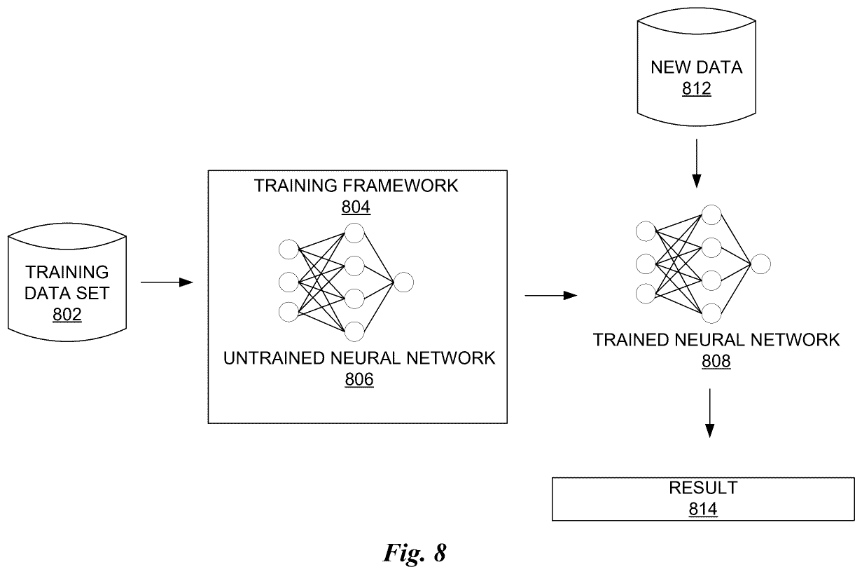

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

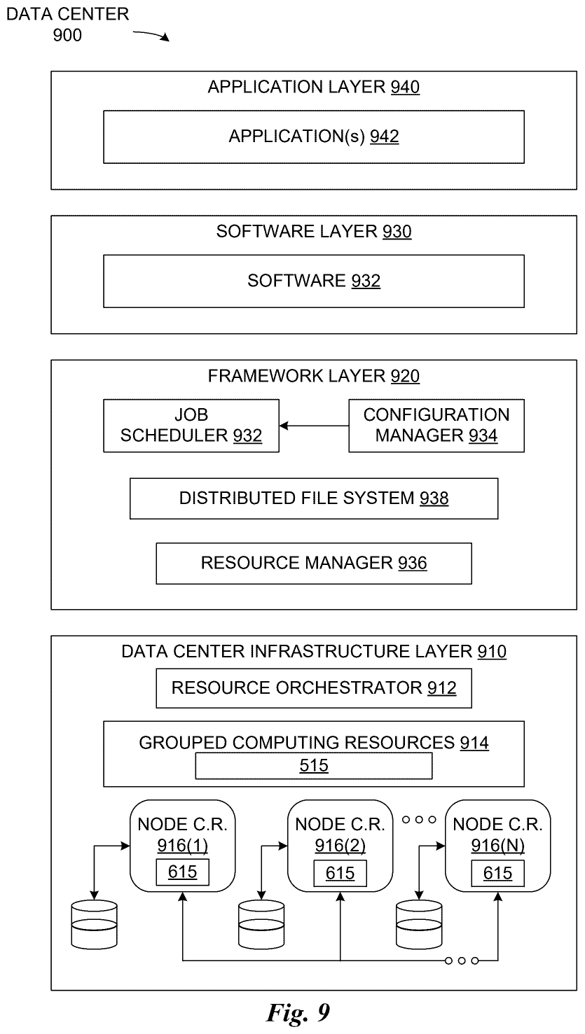

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed for an auto-regressive auto-encoder model that generates variable-length mesh token sequences, from which 3D meshes may be generated. In accordance with FIGS. 1-6, embodiments may provide the auto-regressive auto-encoder model usable for performing inferencing operations and for providing inferenced data. The auto-regressive auto-encoder model may be stored (partially or wholly) in one or both of data storage 601 and 605 in inference and/or training logic 615 as depicted in FIGS. 7A and 7B. Training and deployment of the auto-regressive auto-encoder model may be performed as depicted in FIG. 8 and described herein. Distribution of the auto-regressive auto-encoder model may be performed using one or more servers in a data center 900 as depicted in FIG. 9 and described herein.

What is claimed is:

1. A method, comprising:
at a device:
encoding an input representation of an object into a fixed length latent code;
decoding the fixed length latent code into a variable-length mesh token sequence, by an auto-regressive decoder; and
outputting the variable-length mesh token sequence for use in generating a three-dimensional (3D) mesh for the object.

2. The method of claim 1, wherein the input representation of the object is a point cloud.

3. The method of claim 2, wherein the point cloud is generated from a triangular mesh representing the object.

4. The method of claim 3, wherein the point cloud is generated using a point cloud sampler that samples from the triangular mesh.

5. The method of claim 3, wherein an encoder encodes the input representation of the object into the fixed length latent code.

6. The method of claim 1, wherein the input representation of the object is a single-view image of the object.

7. The method of claim 6, wherein an image encoder extracts image features from the single-view image of the object and wherein a diffusion transformer generates the fixed length latent code conditioned on the image features.

8. The method of claim 1, wherein an encoder is configured to encode a variable length input representation of the object into the fixed length latent code.

9. The method of claim 1, wherein the fixed length latent code is generated based on a predefined number of random points sampled from a surface of the input representation of the object.

10. The method of claim 1, wherein the variable-length mesh token sequence is output to a de-tokenizer that transforms the variable-length mesh token sequence into the 3D mesh.

11. The method of claim 10, wherein the variable-length mesh token sequence is communicated over a network to the de-tokenizer.

12. The method of claim 10, wherein the de-tokenizer transforms the variable-length mesh token sequence into the 3D mesh conditioned on a defined face count that controls a number of faces included in the 3D mesh.

13. The method of claim 12, wherein the defined face count is customizable.

14. The method of claim 1, wherein the variable-length mesh token sequence is a 1D token sequence.

15. The method of claim 1, wherein the variable-length mesh token sequence is a lossless compressed representation of the 3D mesh.

16. The method of claim 15, wherein the variable-length mesh token sequence exhibits at least 40% compression of the 3D mesh.

17. The method of claim 1, wherein the variable-length mesh token sequence is generated using a tokenizer that maximizes edge sharing between adjacent triangles, wherein each next triangle only requires one additional vertex by sharing an edge with a previous triangle.

18. The method of claim 1, wherein the 3D mesh is output to a downstream application.

19. The method of claim 18, wherein the downstream application generates 3D content using the 3D mesh.

20. A system, comprising:
a non-transitory memory storage comprising instructions; and
one or more processors in communication with the memory, wherein the one or more processors execute the instructions to:
encode an input representation of an object into a fixed length latent code;
decode the fixed length latent code into a variable-length mesh token sequence, by an auto-regressive decoder; and
output the variable-length mesh token sequence.

21. The system of claim 20, wherein the variable-length mesh token sequence is a lossless compressed representation of the 3D mesh.

22. The system of claim 20, wherein the 3D mesh is output to a downstream application.

23. The system of claim 22, wherein the downstream application generates 3D content using the 3D mesh.

24. A non-transitory computer-readable media storing computer instructions which when executed by one or more processors of a device cause the device to:
encode an input representation of an object into a fixed length latent code;
decode the fixed length latent code into a variable-length mesh token sequence, by an auto-regressive decoder, and
output the variable-length mesh token sequence.

25. The non-transitory computer-readable media of claim 24, wherein the variable-length mesh token sequence is a lossless compressed representation of the 3D mesh.

26. The non-transitory computer-readable media of claim 24, wherein the 3D mesh is output to a downstream application.

27. The non-transitory computer-readable media of claim 26, wherein the downstream application generates 3D content using the 3D mesh.
